(19) United States
(12) Patent Application Publication
(10) Pub. No.: US 2007/0097366 A1
(43) Pub. Date: May 3, 2007

(54) Optical system and method for detecting particles

(75) Inventors: Steven Francis LeBoeuf, Schenectady, NY (US); Alexei Vertiatchikh, Niskayuna, NY (US); Stanton Earl Weaver JR., Northville, NY (US); Radislav Alexandrovich Potyrailo, Niskayuna, NY (US); Xian-An Cao, New Paltz, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 11/262,210

(22) Filed: Oct. 31, 2005

(51) Int. Cl. G01N 21/00

(52) U.S. Cl. 356/338

(57) ABSTRACT

Embodiments of the invention include a particle detection system that includes a light emitting source, a non-collimating reflector, a collimating reflector, and a detector. Light from the light emitting source is directed by the non-collimating reflector to an area through which a particle stream may be transmitted. Fluorescent light from the light striking particles is redirected to the collimating reflector and then on to the detector. Other embodiments include a single pump used to pull a pair of fluid flows through the detection system. Other embodiments include a plurality of light emitting sources whose light is directed to a particle stream by a single reflector. Other embodiments include a method for detecting particles.

### BACKGROUND

Optical systems and methods are useful in detecting particles. One type of optical system is a fluorescent biological particle detection system. Particulate detection has certain security-related uses, such as, for example, ascertaining the introduction of potentially hazardous air-borne biological particles to an environment. Determining the size of air-borne particles can assist in identifying whether the particles are respirable or not. Further, air-borne particles may be subjected to a light source capable of inducing an emission of fluorescence from the particles. For example, fluorescence detected in the 400 to 540 nanometer (nm) range signals the presence of nicotinamide adenine dinucleotide hydrogen, which is indicative of biological activity or viability. See, for example, U.S. Pat. Nos. 5,701,012 and 5,895,922.

Optical particle detection also is used in commercial smoke detectors, where optical scatter detection is used to signify the presence of an airborne particle. Particle counters also are used in the semiconductor industry to monitor air cleanliness for the particle-sensitive photolithography step. By measuring the absorption of certain optical wavelengths, one also can measure the presence of specific chemicals, such as NOₓ, CO₂, or carbon monoxide. Fourier-transform infrared spectroscopy (FTIR) detection can be used to identify the presence of ice and water vapor. In this sense, the term “particle” refers to any individual mass or collection of masses that can interact with energy—most typically electromagnetic energy.

Disadvantages have been noted in known particle detector systems. One disadvantage is that known detector systems have high noise to signal ratios, due primarily to stray light and a low particle detection cross-section. Known particle detector systems may utilize lasers or laser diodes as light emitting sources. Known fluorescent particle detector systems utilize a collimating lens prior to striking the target particles. Also, known particle systems utilize conduits that are not fully optically transparent.

### SUMMARY

One embodiment of the invention described herein is directed to a particle detection system that includes at least one light emitting source for generating light, a non-collimating reflector for redirecting the generated light, an area through which a particle stream may be transmitted and into which the generated light is redirected, a collimating reflector, and at least one detector. At least a portion of energy formed by the redirected generated light striking one or more particles in the particle stream is directed to the collimating reflector and redirected to the detector(s).

Another embodiment of the invention is directed to an optical system for detecting particles that includes an air-sheath inlet through which a curtain of air is introduced, a conduit radially interior to the air-sheath inlet through which a particle stream is transmitted, and a pumping system consisting of a single pump positioned downstream of the air-sheath inlet and the conduit and configured to enable transmission of the particle stream and introduction of the curtain of air.

Another embodiment of the invention is an optical system for detecting particles that includes a plurality of light emitting sources for generating light and a light redirecting system consisting of a single reflector for redirecting the generated light. Each of the light emitting sources transmits generated light at the single reflector that redirects the generated light toward a stream of particles.

Another embodiment of the invention is a method for detecting particles. The method includes introducing a stream of particles into an enclosed container, transmitting light at a non-collimating reflector, redirecting the light to a focal point within the stream of particles, collecting incident light formed by the striking of the generated light upon at least one particle within the stream of particles, and transmitting the incident light to at least one detector.

These and other advantages and features will be more readily understood from the following detailed description of preferred embodiments of the invention that is provided in connection with the accompanying drawings.

### BRIEF DESCRIPTION OF THE DRAWINGS

FIG. 1a illustrates a particle detection system constructed in accordance with an exemplary embodiment of the invention.

FIG. 1b is a partial view of a portion of the particle detection system of FIG. 1a beneath the cover plate.

FIG. 2 is a cross-sectional view of a portion of the particle detection system of FIG. 1a taken along line II-II.

FIG. 3 is a perspective view of the particle detection system of FIG. 1a.

FIG. 4 is a schematic view illustrating the modification of generated light to fluorescent light and then to reflected light within the particle detection system of FIG. 1a.

FIG. 5a is a schematic view illustrating generated light being transmitted into an excitation zone within the particle detection system of FIG. 1a.

FIG. 5b is a schematic view illustrating fluorescent light being transmitted from the excitation zone and reflected light being transmitted to a detector within the particle detection system of FIG. 1a.

FIG. 6 illustrates a process for identifying a particle type within a particle stream in accordance with an embodiment of the invention.

### DETAILED DESCRIPTION OF PREFERRED EMBODIMENTS

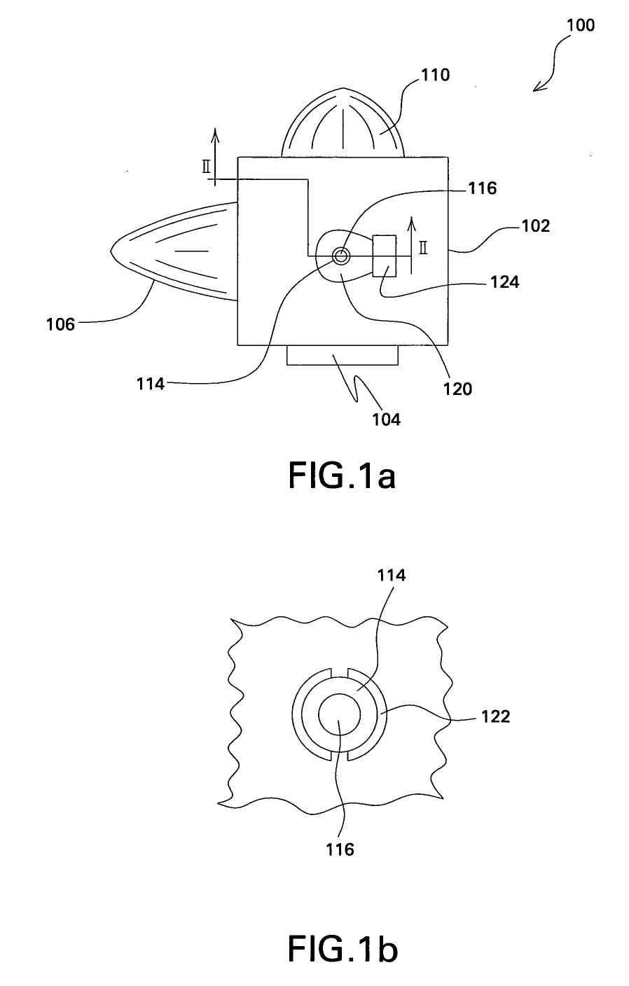

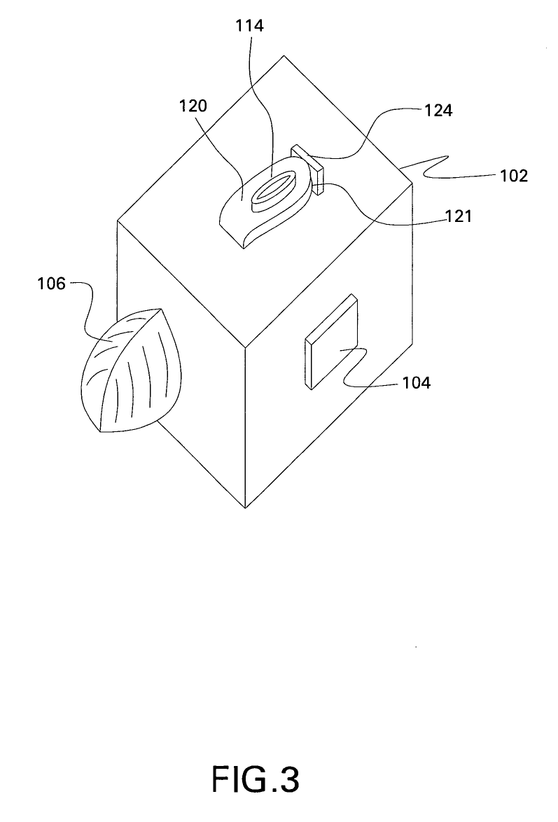

Referring specifically to FIGS. 1a-3, there is shown an optical detection system 100 that includes an enclosure 102, a detector 104, a first reflector 106, a second reflector 110, an intake mechanism 113, and a pump 136. The optical detection system 100 may take the form of a fluorescent particle detection system. In certain embodiments, the first reflector 106 may be a non-collimating reflector, and in some embodiments the second reflector 110 may be a collimating reflector. The term “non-collimating” should be understood to refer to a reflective surface that does not have as a primary purpose the collimating of light, although some degree of collimation may nevertheless exist. First reflector 106 may include a coating 108, while the second reflector 110 may include a coating 112. The reflective coatings 108, 112 may be disposed on an inner surface (meaning a surface facing the interior 130 of the enclosure 102), thus serving to reflect any light striking such surface from within the enclosure 102. Alternatively, the reflective coatings 108, 112 may be disposed on an outer surface (meaning a surface facing away from the interior 130 of the enclosure 102), thus serving to refract any light striking, respectively, the first reflector 106 or the second reflector 110 from within the enclosure 102. In some aspects, the profile for the first and second reflectors 106, 110 may be curved, parabolic, spherical, holographic, or elliptical. As illustrated, the first reflector 106 has an elliptical profile, while the second reflector 110 has a spherical profile.

The intake mechanism 113 includes a pair of concentric inlets. Specifically, the intake mechanism 113 includes a particle inlet 114 having an opening 116 extending through a cover plate 120 and into the interior 130 of the enclosure 102 and concentric air inlet 122 disposed radially exterior to the particle inlet 114. The cover plate 120 is attached to a surface of the enclosure 102 in such a way as to enclose the air inlet 122 underneath. An air filter 124 is attached to an open end 121 of the cover plate 120 to allow for filtered air to be transmitted through the air inlet 122.

The air inlet 122 is concentric with the opening 116 of the particle inlet 114. The particle inlet 114 may be attached to the cover plate 120, in which case the air inlet 122 may extend completely around the particle inlet 114. In other embodiments, and as illustrated in FIG. 1b, the particle inlet 114 is attached to the enclosure 102, and therefore the air inlet 122 does not extend completely around the particle inlet 114. The openings for the air inlet 122 may be smooth-walled or they may be grooved to provide a spiral flow of air through the air inlet 122 and into the interior 130 of the enclosure 102. In other embodiments, the air inlet 122 may be nonexistent and another optically transparent conduit may be utilized to segregate the particle stream 118 from the remaining environment of the interior 130 of the enclosure 102.

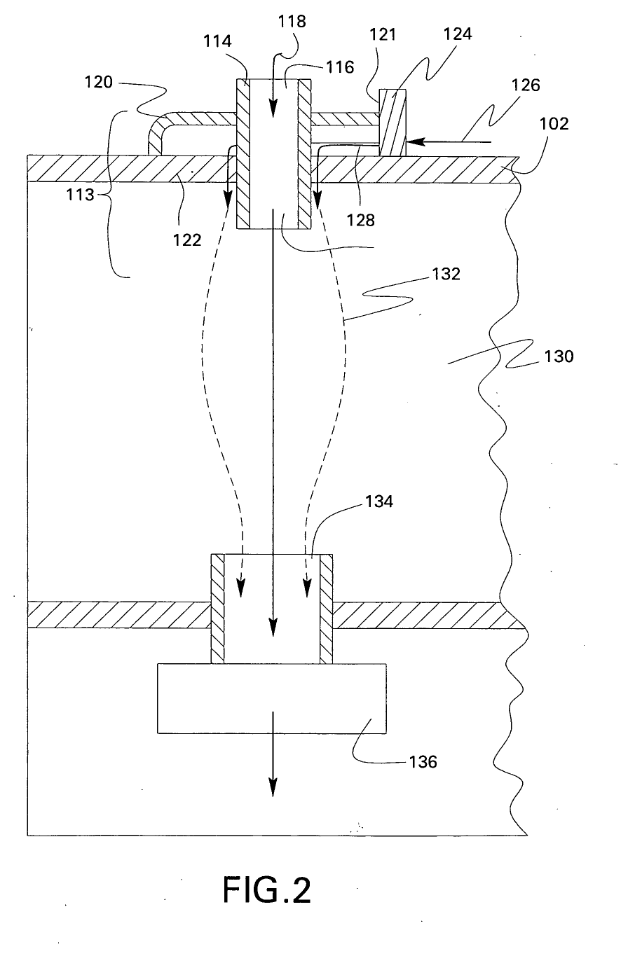

Particles are introduced into the interior 130 of the enclosure within a particle stream 118 (FIG. 2). Air is introduced into the interior 130 of the enclosure by passing an air stream 126 through the air filter 124 to produce a filtered air stream 128. A filtered air stream 128 is advantageous in that it lessens the likelihood that particulates from the air stream can cause an erroneous fluorescence signature for the particle stream 118. The pump 136 provides the pressure differential necessary to pull both the particle stream 118 and the filtered air stream 128 into the interior 130 of the enclosure 102. Various factors are taken into account to enable the air stream 126 extending into the interior 130 of the enclosure 102 to serve as an air-sheath 132 to the particle stream 118. Specifically, the pumping power of the pump 136, the distance into the interior 130 that the particle inlet 114 extends, the initial velocity of the particle stream 118, the size of the particle inlet 114, and the size of the sheath flow inlet 122 all may be manipulated to ensure that the total flow of the air-sheath 132 is sufficiently less than the total flow of the particle stream 118 within the interior 130 to fully enshroud the particles within the particle stream 118. Nonetheless, the velocity of the air-sheath 132 is greater than the velocity of the particle stream 118. The difference in the velocities of the air-sheath 132 and the particle stream 118 within the interior 130 creates a pressure differential causing the particle stream 118 to remain within the air-sheath 132. Further, the various factors are manipulated to ensure that the particle stream 118 has no turbulent flow within the air-sheath 132. If either the velocity of the flow of air constituting the air-sheath 132 or the velocity of the radially inner particle stream 118 is too high, turbulence may be induced. Turbulence may coat the optical components of the optical detection system 100 and destroy optical sensitivity. In general, a turbulent flow is acceptable as long as particles do not coat optical surfaces, such as, for example, surfaces of a window 144, an optical filter 140, a beam dump 138, or the coating 112.

The air-sheath 132 serves as an optically transparent conduit serving to isolate the particle stream 118 from the remainder of the interior 130. It should be appreciated that other optically transparent conduits may be utilized to isolate the particle stream 118, such as, for example, poly ether ether ketone (PEEK), Teflon AF, fused silica, quartz, sapphire, or other transparent, low auto-fluorescent media capable of being formed into a conduit.

As the air-sheath 132 and the particle stream 118 extend closer to the pump 136, the air-sheath 132 begins to collapse radially inwardly toward the particle stream 118, and both streams 118, 132 exit the interior 130 through an outlet 134, which is in fluid connection with the pump 136. Through the use of the air-sheath 132, the particle stream 118 is isolated from the environment through an optically transparent mechanism, thereby enabling a more accurate optical measurement of particles within the particle stream 118.

An additional benefit of the air-sheath 132 is that it can assist in cleaning the interior walls of the enclosure 102. Further, by ramping up the pump 136 intermittingly, a turbulent regime can be initiated to clean the interior 130 of the optical detection system 100. Optionally, ultrasonic waves may be used to clean the interior walls of the enclosure 102.

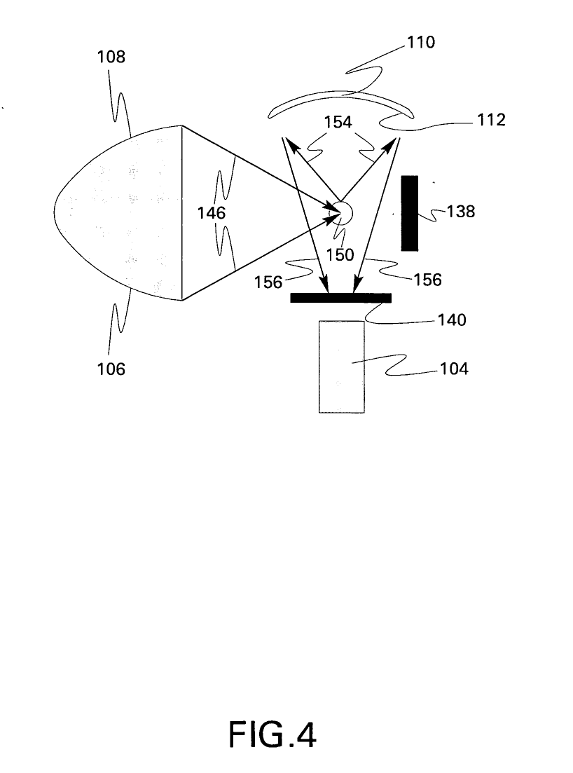

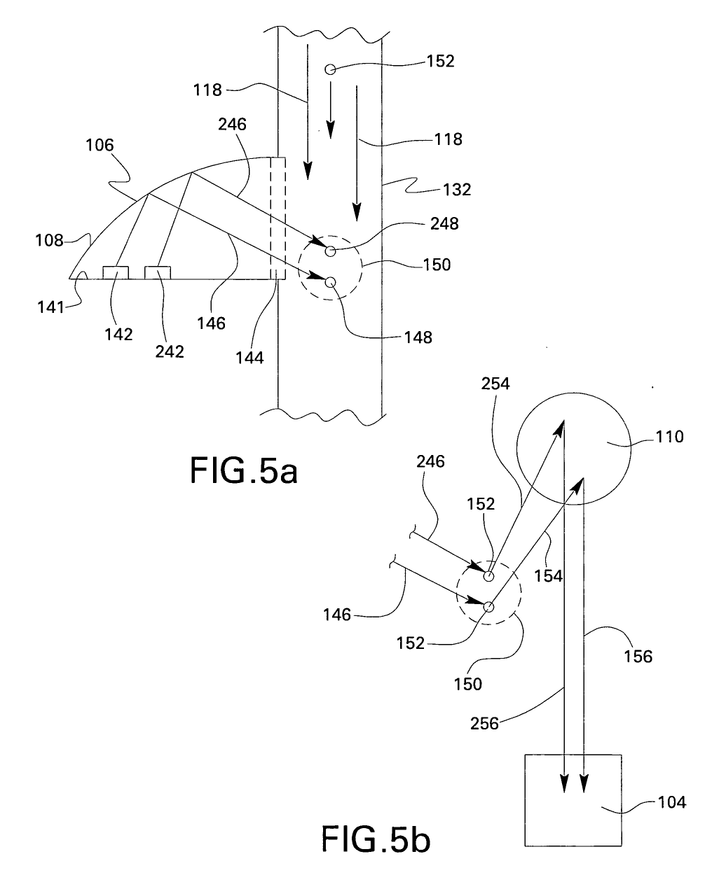

With specific reference to FIGS. 4-5b, next will be described the optics of the optical detection system 100. One or more light sources are located beneath the first reflector 106. As illustrated in FIG. Sa, a first light emitting source 142 is disposed upon a surface 141. An optional second light emitting source 242 is also shown disposed upon the surface 141. It should be appreciated that more than two light emitting sources may be positioned beneath the first reflector 106. The positioning of the light emitting sources 142, 242 is accomplished to ensure that light reflected, refracted or diffused from the first reflector 106 is transmitted into an excitation zone 150 that is located within the particle stream 118 within the interior 130. Specifically, geometrical optics are utilized whereby upon determining the location of the target, i.e., the excitation zone 150, the placement of the light emitting source(s) is accomplished by working backward, using known distances and angles. It should be appreciated that the excitation zone 150 should be located at a position within the particle stream 118 that is at a distance from the position at which the air-sheath 132 begins to collapse inwardly.

As illustrated, the first light emitting source 142 emits a light 146 which strikes the coated surface of the first reflector 106 and bounces into the excitation zone 150 at a focal spot 148. The second (optional) light emitting source 242 emits a light 246 which strikes the coated surface of the first reflector 106 and reflects into the excitation zone 150 at a focal spot 248. It should be appreciated that any suitable light emitting source 142, 242 may be utilized, such as, for example, light emitting diodes, including surface-emitting light emitting diodes, ultraviolet light emitting diodes, edge-emitting light emitting diodes, resonant cavity light emitting diodes, flip-chipped light emitting diodes, gas-discharge lamps, mercury lamps, filament lamps, black-body radiators, chemo-luminescent media, organic light emitting diodes, phosphor upconverted sources, plasma sources, solar radiation, sparking devices, vertical light emitting diodes, and wavelength-specific light emitting diodes, lasers, and laser diodes, and any other suitable light emitting device capable of emitting a sufficiently high intensity light of the desired wavelength. By “sufficiently high intensity light” is meant a light of sufficient intensity to induce an effective optical signal, such as particle fluorescence. The term “wavelength” should be understood to encompass a range of wavelengths and to refer to a spectral range of electromagnetic energy. Furthermore, the light emitting source 142, 242 may be pulsed to achieve the desired intensity of light without sacrificing reliability or lifetime. Another advantage of a very fast pulsed source, such as an LED, would be to synchronize the detector to the source for the purpose of improving the signal to noise ratio. A heat sink may be attached to the light-emitting source 142, 242 to enhance heat dissipation.

An optically transparent window 144 may be positioned between the first reflector 106 and the interior 130 of the enclosure 102. The optically transparent window 144 may include an optical filter for lessening the amount of parasitic light that is in the range of the detection spectrum from entering the interior 130 of the enclosure and producing parasitic signals in the form of scattered light.

A particle 152 traveling within the particle stream 118 enters the excitation zone 150. As the particle 152 encounters the focal spot 148, 248, the redirected generated light 146, 246 strikes the particle 152, creating an optical signal 154, 254. It should be appreciated that the optical signal may be fluorescence, absorption, transmission, reflectance, and/or scattering. For ease of description, the optical signals 154, 254 will be described herein as being fluorescent in nature. Most of the fluorescent light 154, 254 scatters throughout the interior 130 of the enclosure 102. This backscattered light eventually dissipates into a beam dump 138. The backscattered light may be used to detect dirtiness within the interior 130 of the enclosure 102. For example, a predetermined intensity of backscattered light may represent a certain threshold level of cleanliness within the enclosure 102, and any backscattered light lacking that predetermined intensity to a certain degree may represent a dirtier interior 130.

The remaining fluorescent light 154, 254 strikes the coated surface of the second reflector 110. The second reflector 110 may be a collimating reflector. Reflected light 156, 256 is directed toward the detector 104. The detector 104 may be a photoconductor, a photodiode, a photomultiplier tube, or an avalanche photodiode, or any photo detector capable of detecting single photons or collections of single photons. An optional optical filter 140 may be positioned between the second reflector 110 and the detector 104. The optical filter 140 may be filtered to specific wavelengths, thus serving to eliminate one or more portions of the light spectrum to decrease the noise to signal ratio.

The first reflector 106, the second reflector 110 and the detector 104 are all shown to be orthogonal to each other. Such an arrangement is advantageous in that neither reflector is in direct sight of the other, thereby lessening the reflection of direct light 146, 246 into the detector 104. It should be appreciated, however, that absolute orthogonality may not be required, and the first reflector 106 may be somewhat less than or more than ninety degrees offset from the second reflector 110, which in turn may be somewhat less than or more than one-hundred and eighty degrees offset from the detector 104.

The light emitting sources 142, 242 and the detectors 104 may be tuned to the absorption and emission profiles of various particles. For example, at least one light emitting source 142, 242 may emit light at a first wavelength at which a predetermined particle fluoresces while another of the light emitting sources 142, 242 may emit light at a second wavelength at which a second predetermined particle fluoresces. It should be appreciated that certain particles fluoresce at more than one wavelength, and thus the first and second predetermined particles may indeed be the same particles. Alternatively, each of the light emitting sources 142, 242 may emit light at a wavelength at which several types of particles fluoresce and each of the detectors 104 is tuned to detect the fluorescent light at wavelengths differing from the other of the detectors 104.

When several excitation wavelengths are employed and corresponding emission spectra are collected, this collection of spectra constitutes an excitation-emission map. Suitable methods for determination of fluorescence-excitation maps are provided in, for example, U.S. Pat. Nos. 6,166,804 and 6,541,264. Fluorescence excitation-emission maps are useful because they provide a more comprehensive spectral signature for a single species and provide a more detailed capability to reveal if more than one fluorescent species are present in a measured sample.

For example, a 280 nm UV source and 365 nm UV source can be turned on alternately such that an incoming particle stream is hit with one UV wavelength at a time. Bacteria will fluoresce primarily in the 340 nm range, due to protein fluorescence, upon exposure to 280 nm UV radiation. Bacteria will fluoresce primarily in the 430-550 nm range upon excitation with 365 nm UV light, due to NADH and flavin fluorescence. In contrast, many common fluorescent interferents, such as diesel soot and many vegetable oil aerosols, show significant fluorescence at only one of these excitation wavelengths. Thus, with one photo detector optically filtered at 340 nm and another photo detector optically filtered at 430-550 nm, a sufficient algorithm can be developed for discriminating airborne bacteria from common interferents. Table 1 provides a summary of fluorescence ranges for bio-agents and common interferents exposed to light at various wavelengths.

TABLE 1

| | | λ_{excit} = | |
|---|---|---|---|
| Agent | λ_{excit} = 280 nm | 340/365 nm | λ_{excit} = 405 nm |
| Vegetative | Tryptophan | NADH + Flavins | Flavins |
| Bacteria | (320-360 nm); | (430-600 nm) | (500-600 nm) |
| | Flavins | | |
| | (500-600 nm) | | |
| Spores | Tryptophan & | Possible NADH, | Flavins |
| | Flavins | but dim | (500-600 nm) |
| Viruses | Tryptophan & | Non-detectable | Non-detectable |
| | Flavins | | |
| Toxins | Tryptophan | Non-detectable | Non-detectable |
| Vegetable Oil | Non-detectable | 400-550 nm | 450-500 nm |
| Diesel Soot | Dim 380-500 nm | Dim 380-500 nm | 410-650 nm |
| Fluospheres | Dim 280 nm | 400-500 nm | Non-detectable |
| Road Dust | Non-detectable | Non-detectable | Non-detectable |

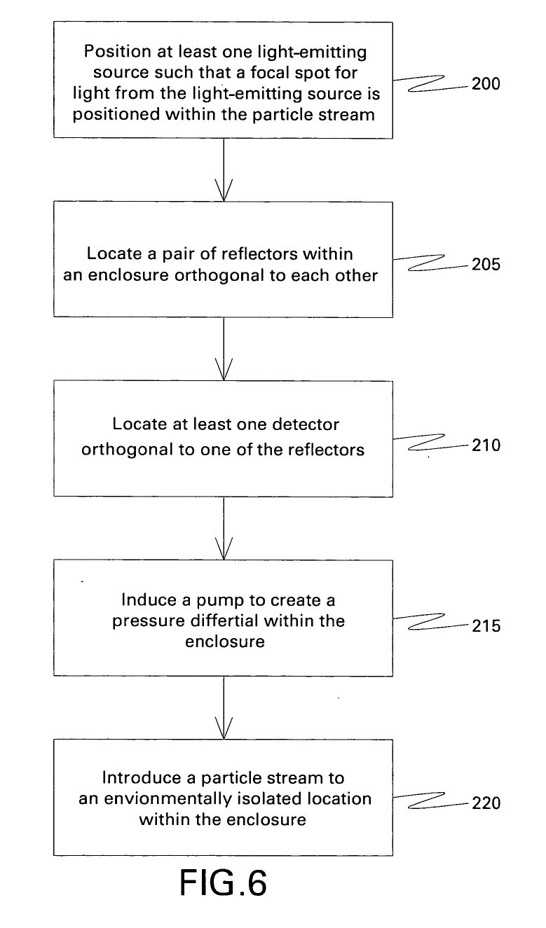

With specific reference to FIG. 6, next will be described a method for analyzing a particle stream to ascertain the presence of predetermined particles of interest. At Step 200, at least one light emitting source, such as light emitting sources 142, 242, is positioned such that a focal spot 148, 248 for light emitted from the light emitting sources is positioned within the particle stream 118. Such positioning may utilize geometrical optics by working backward from the desired location of the focal spot to the appropriate location of the light emitting source.

At Step 205, a pair of reflectors, such as reflectors 106, 110, is located within an enclosure 102. The reflectors are placed relative to one another such that direct light from the first reflector 106 does not impinge directly upon the second reflector 110. For example, the reflectors 106, 110 may be placed orthogonal to one another. At Step 210, at least one detector, such as detector 104, is located relative to the two reflectors. Specifically, the detector 104 is placed so as to receive light directly from the second reflector 110 but be out of direct sight of the first reflector 106. For example, the detector 104 may be placed directly opposite the second reflector 110 and orthogonal to the first reflector 106.

At Step 215, a pump, such as pump 136, is engaged to induce a pressure differential within the enclosure 102. At Step 220, a particle stream is introduced into an environmentally isolated location. As described with reference to FIGS. 1a-5b, a particle stream 118 is introduced through a particle inlet 114 into the interior 130 of the enclosure 102 and concentrically within the air-sheath 132. The pump serves to pull both the air-sheath 132 and the particle stream 118 through the enclosure 102.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. For example, while the enclosure 102 is illustrated as being cubic, it should be appreciated that the enclosure 102 may take any suitable configuration. Further, while optional optical filters have been described with reference to the detector 104 and the window 144, it should be appreciated that each light emitting source may itself incorporate an optical filter. Also, while the velocity of the illustrated air-sheath 132 is described as being greater than the velocity of the particle stream 118, it should be understood that the velocity of the air-sheath 132 can be any velocity relative to the particle stream 118 velocity. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed as new and desired to be protected by Letters Patent of the United States is:

1. a particle detection system, comprising:
at least one light emitting source for generating light;
a non-collimating reflector for redirecting the generated light;
an area through which a particle stream may be transmitted and into which the generated light is redirected;
a collimating reflector; and
at least one detector;
wherein at least a portion of energy formed by the redirected generated light striking one or more particles in the particle stream is directed to said collimating reflector and redirected to said at least one detector.

2. The particle detection system of claim 1, wherein said energy comprises electromagnetic radiation.

3. The particle detection system of claim 2, wherein said electromagnetic radiation comprises fluorescent light.

4. The particle detection system of claim 2, wherein said electromagnetic radiation comprises scattered light.

5. The particle detection system of claim 2, wherein said electromagnetic radiation comprises fluorescent light and scattered light.

6. The particle detection system of claim 1, wherein said non-collimating reflector is positioned relative to said collimating reflector such that the redirected generated light from said non-collimating reflector is not visible to said collimating reflector.

7. The particle detection system of claim 6, wherein said non-collimating reflector and said collimating reflector are positioned orthogonal to one another.

8. The particle detection system of claim 1, wherein said at least one light emitting source comprises one or more from the group consisting of light emitting diodes, surface-emitting light emitting diodes, ultraviolet light emitting diodes, edge-emitting light emitting diodes, resonant cavity light emitting diodes, flip-chipped light emitting diodes, gas-discharge lamps, mercury lamps, filament lamps, black-body radiators, chemo-luminescent media, organic light emitting diodes, phosphor upconverted sources, plasma sources, solar radiation, sparking devices, vertical light emitting diodes, wavelength-specific light emitting diodes, lasers, laser diodes.

9. The particle detection system of claim 1, wherein one of said at least one light emitting source emits light at a first wavelength at which a first specific particle fluoresces and at least one other of said at least one light emitting source emits light at a second wavelength at which a second specific particle fluoresces.

10. The particle detection system of claim 1, wherein each of said at least one light emitting source emits light at a first wavelength at which several types of particles fluoresce and each of said at least one detector detects said fluorescent light at a wavelength differing from the other of said at least one detector.

11. The particle detection system of claim 1, wherein said non-collimating reflector comprises a reflective surface.

12. The particle detection system of claim 1, wherein said non-collimating reflector is curved, parabolic, spherical, holographic, or elliptical in configuration.

13. The particle detection system of claim 1, wherein said area is formed within an air-sheath.

14. The particle detection system of claim 13, further comprising a conduit through which the particle stream is transmitted into said area and a concentric air-sheath inlet through which said air-sheath is introduced.

15. The particle detection system of claim 14, further comprising a pump configured to enable transmission of the particle stream through said area and radially interior to said air-sheath.

16. The particle detection system of claim 13, further comprising a filter configured for filtering air for said air-sheath.

17. The particle detection system of claim 1, wherein said collimating reflector comprises a reflective surface.

18. The particle detection system of claim 1, wherein said at least one detector comprises at least one from the group consisting of a photoconductor, a photodiode, a photomultiplier tube, an avalanche photodiode, or any photo detector capable of detecting single photons or collections of single photons.

19. An optical system for detecting particles, comprising:
an air-sheath inlet through which a stream of air is introduced;
a conduit radially interior to said air-sheath inlet through which a particle stream is transmitted; and
a pumping system consisting of a single pump positioned downstream of said air-sheath inlet and said conduit and configured to enable transmission of the particle stream and introduction of said stream of air.

20. The optical system of claim 19, comprising:
at least one light emitting source for generating light;
an excitation area through which the particle stream is transmitted and into which said generated light is transmitted.

21. The optical system of claim 20, wherein said at least one light emitting source comprises a plurality of light emitting sources located in a same plane and capable of generating a plurality of beams of light for transmission into said excitation area.

22. The optical system of claim 20, comprising:
a first reflector for redirecting the generated light into the excitation area;
a second reflector for collecting and collimating light from said excitation area; and
at least one detector for detecting collimated light from said second reflector.

23. The optical system of claim 22, wherein said first reflector comprises a reflective surface.

24. The optical system of claim 23, wherein said reflective surface is located on an exterior surface of said first reflector.

25. The optical system of claim 22, wherein said second reflector comprises a reflective surface.

26. The optical system of claim 25, wherein said reflective surface is located on an exterior surface of said second reflector.

27. An optical system for detecting particles, comprising:
a plurality of light emitting sources for generating light;
a light redirecting system consisting of a single reflector for redirecting the generated light;
wherein each of said light emitting sources transmits said generated light at said single reflector which redirects the generated light toward a stream of particles.

28. The optical system of claim 27, comprising:
a collimating reflector for collecting and collimating light transmitted from the stream of particles; and
at least one detector for detecting collimated light from said collimating reflector.

29. The optical system of claim 27, further comprising an air-sheath, wherein the stream of particles is formed radially interior to said air-sheath.

30. The optical system of claim 29, further comprising a conduit through which the stream of particles is transmitted and a concentric air-sheath inlet through which said air-sheath is introduced.

31. The optical system of claim 30, further comprising a pump configured to enable introduction of said air-sheath and transmission of the stream of particles radially interior to said air-sheath.

32. The optical system of claim 27, wherein one of said light emitting sources emits light at a first wavelength at which a first specific particle fluoresces and at least one other of said light emitting sources emits light at a second wavelength at which a second specific particle fluoresces.

33. The optical system of claim 27, wherein each of said light emitting sources emits light at a first wavelength at which several types of particles fluoresce and each of said at least one detector detects at a wavelength differing from the other of said at least one detector.

34. A method for detecting particles, comprising:
introducing a stream of particles into an enclosed container;
transmitting light at a non-collimating reflector;
redirecting the light to a focal point within the stream of particles;
collecting incident light formed by the striking of the light upon at least one particle within the stream of particles; and
transmitting the incident light to at least one detector.

35. The method of claim 34, wherein said introducing comprises introducing the stream of particles within an optically transparent conduit.

36. The method of claim 35, wherein said introducing comprises introducing the stream of particles radially interior to an air-sheath.

37. The method of claim 36, wherein said introducing occurs at a velocity less than that of the air-sheath and below that at which turbulence of the stream of particles occurs.

38. The method of claim 34, wherein said transmitting light comprises transmitting light from at least one light emitting source.

39. The method of claim 38, wherein said redirecting comprises:
determining the desired location of the focal point within the stream of particles; and
ascertaining the appropriate placement of the at least one light emitting source from the desired location.

40. The method of claim 34, wherein said collecting is accomplished with a collimating reflector.

41. The method of claim 40, further comprising forming fluorescent light by the redirected light striking one or more particles in the particle stream, the fluorescent light being directed to the collimating reflector and redirected to the at least one detector.
